(19) United States
(12) Patent Application Publication
(10) Pub. No.: US 2025/0385864 A1
(43) Pub. Date: Dec. 18, 2025

(54) Preventing Micro-Loops During Re-convergence by Validating Backup Paths

(71) Applicant: Arista Networks, Inc., Santa Clara, CA (US)

(72) Inventors: Vivek ILANGOVAN, Bengaluru (IN); Arunprakash SEKAR, Bengaluru (IN); Arpit BANSAL, Bengaluru (IN)

(21) Appl. No.: 18/886,010

(22) Filed: Sep. 16, 2024

Related U.S. Application Data
(60) Provisional application No. 63/659,638, filed on Jun. 13, 2024.

(51) Int. Cl. H04L 45/28; H04L 43/0823

(52) U.S. Cl. CPC H04L 45/28; H04L 43/0847

(57) ABSTRACT

A node in a deployment uses a mechanism to avoid micro-loop losses during re-convergence after a failed resource, such as a link or a node, includes running a local timer for a period of time. The node uses a loop-free backup path to forward traffic while the timer is running instead of using its forwarding tables. Use of the backup path reduces the risk of a micro-loop while the deployment re-converges, In response to the node receiving an event message, the timer is allowed to continue running as the backup path is validated. Normal forwarding processing resumes when the timer expires or when the timer is aborted in response to determining that the backup path is invalid.

### CROSS REFERENCE TO RELATED APPLICATIONS

Pursuant to 35 U.S.C. § 119(e), this application is entitled to and claims the benefit of the filing date of U.S. Provisional App. No. 63/659,638 filed Jun. 13, 2024, the content of which is incorporated herein by reference in its entirety for all purposes.

### BACKGROUND

Micro-loops are transient forwarding loops that can arise during periods when a network is re-converging following a change in network topology; e.g., due to a link failure, a node failure, reconfiguration by a user, etc. During re-convergence, micro-loops may occur over a single link between a pair of routers that temporarily use each other as the next hop for a prefix.

Documents of the Internet Engineering Task Force (IETF) called Request for Comment (RFC) 7490, RFC 8333, and a draft document of the IETF identified as “draft-ietf-rtgwg-segment-routing-ti-lfa-13,” (collectively the “IETF documents”) describe elements of a mechanism for routing protocols, generally referred to as interior gateway protocols (IGPs), to reduce the occurrence of local micro-loops in case of a link or node failure. The mechanism involves a two-step convergence process by introducing a delay between convergence of the node adjacent to the topology change (i.e., the node affected by the failure) and the network-wide convergence. The foregoing IETF documents are incorporated herein by reference for all purposes.

A local timer is initiated in the affected node during which time the affected node commences forwarding traffic using a pre-computed backup path instead of its normal forwarding process (e.g., using its routing and forwarding tables). The pre-computed backup path is loop free, whereas the normal forwarding processing using the node's routing/forwarding (forwarding) tables may result in micro-loops. Forwarding the traffic using the pre-computed backup path gives time for other nodes in the topology to converge; i.e., allow nodes to update their routing/forwarding tables. After the timer expires, the affected node can resume normal forwarding processing instead of forwarding on the backup path.

In accordance with the IETF documents, the local timer should immediately terminate in the presence of any uncorrelated event to avoid using the backup path in case the uncorrelated event is an event that invalidates the backup path. An uncorrelated event can be any event that is not related to or otherwise associated with the original failure. However, in the case of a large deployment, many uncorrelated events can occur that have nothing to do with the backup path. As such, the likelihood that the local timer will be terminated before achieving convergence is very high, thus increasing the likelihood of a micro-loop occurrence.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 is a high level block diagram representation of a network device that can implement backup path processing in accordance with the present disclosure.

FIG. 2 is an illustrative representation of an example deployment used to explain operations in accordance with the present disclosure.

FIG. 3 is a representation of operations in accordance with some embodiments of the present disclosure.

FIGS. 4A, 4B, 4C, 4D illustrates generating a revised topology to add back a failed resource.

FIG. 5 is a representation of operations in accordance with some embodiments of the present disclosure.

### DETAILED DESCRIPTION

The present disclosure describes techniques to prevent micro-loops when re-converging in response to a failed resource such as a link, a node (network device), and so on. Nodes use a category of protocols referred to as Interior Gateway Protocols (IGPs). IGP is a route update protocol to advertise state and route changes throughout the network. Examples include Intermediate System-Intermediate System (IS-IS), Open Shortest Path First (OSPF), Routing Information Protocol (RIP), and others.

When a resource on the shortest path to a forwarding destination node becomes unavailable, a backup path to that destination node is used. In some embodiments, each node in a deployment computes a set of corresponding backup paths to other nodes in the deployment, one backup path for each resource that can fail. When a given node experiences a downed resource (e.g., link, node, or links in a shared risk link group—SRLG—of a failed link), referred to as the protected resource, the given node begins forwarding traffic on a corresponding backup path and advertises the downed resource to the other nodes. A local timer mechanism runs while the network reconverges. Traffic is forwarded on the backup path for the duration of the timer to prevent micro-loops during convergence; i.e., to allow the other nodes to learn of the downed resource and recompute their routes. After the timer expires, the node that experiences the downed resource can resume normal forwarding processing using its routing/forwarding tables instead of the backup path.

The present disclosure provides a micro-loop prevention mechanism using a timer that is not directly controlled (triggered) by the occurrence of advertised events. More specifically, in a given deployment, when a node (Node A) experiences a downed resource in connection with another node (Node B), e.g., because the link to Node B is down, Node B itself is down, etc., the following can be performed:
Node A will:
   1. advertise to nodes in network that the resource is down; this will initiate re-convergence activity among the nodes in the network to learn new routes that exclude the downed A-B path, and
   2. begin forwarding traffic on a pre-computed backup path associated with the downed resource (instead of using its routing/forwarding tables) while the other nodes reconverge.
Node A will start a timer. This timer serves to delay when node A resumes normal forwarding processing of traffic to give the rest of the network time to reconverge, and by doing so avoids occurrence of a micro-loop.
If Node A receives an advertised event while the timer is running, Node A keeps the timer running and verifies whether the backup path is still valid:
   If the backup path is valid, then do nothing and allow the timer to continue running. Node A will continue to forward traffic using the backup path as the network continues to reconverge.
   If the backup path is deemed invalid, then Node A stops the timer, discontinues using the backup path, and resumes normal forwarding processing. The network will continue to reconverge in response to the node A-B link going down.
When the timer expires or is aborted, Node A can resume normal forwarding of traffic; e.g., using its routing/forwarding tables.
   The receiving of an event message triggers making a determination whether the backup path is valid or not valid, and based on the validity of the backup path the timer either continues running or is aborted. The timer is not aborted in response to receiving an event message.

The foregoing is performed by each node that experiences the downed resource. For example, in the case of a downed link between Node A and Node B, both Node A and Node B will perform the above operations, but no other nodes in the deployment performs the algorithm. In the case that Node B is down, then any node that has a link to Node B will perform the above operations.

In the following description, for purposes of explanation, numerous examples and specific details are set forth in order to provide a thorough understanding of embodiments of the present disclosure. Particular embodiments as expressed in the claims may include some or all of the features in these examples, alone or in combination with other features described below, and may further include modifications and equivalents of the features and concepts described herein.

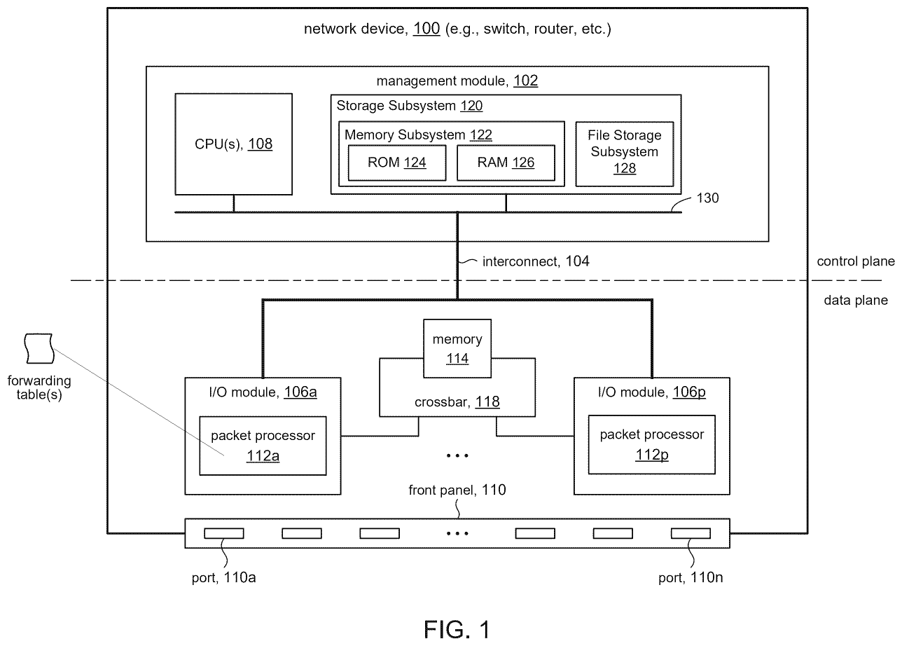

FIG. 1 is a schematic representation of a network device 100 (e.g., a router, switch, firewall, and the like) that can be adapted in accordance with the present disclosure. In some embodiments, for example, network device 100 can include a management module 102, one or more I/O modules (switches, switch chips) 106a-106p, and a front panel 110 of I/O ports (physical interfaces, I/Fs) 110a-110n. Management module 102 can constitute the control plane of network device 100 (also referred to as the control layer or simply the central processing unit, CPU), and can include one or more CPUs 108 for managing and controlling operation of network device 100 in accordance with the present disclosure. Each CPU 108 can be a general-purpose processor, such as an Intel®/AMD® x86, ARM® microprocessor and the like, that operates under the control of software stored in a memory device/chips such as read-only memory (ROM) 124 or random-access memory (RAM) 126. The control plane provides services that include traffic management functions such as routing, security, load balancing, analysis, and the like.

The one or more CPUs 108 can communicate with storage subsystem 120 via bus subsystem 130. Other subsystems, such as a network interface subsystem (not shown in FIG. 1), may be on bus subsystem 130. Storage subsystem 120 can include memory subsystem 122 and file/disk storage subsystem 128. Memory subsystem 122 and file/disk storage subsystem 128 represent examples of non-transitory computer-readable storage devices that can store program code and/or data, which when executed by one or more CPUs 108, can cause one or more CPUs 108 to perform operations in accordance with embodiments of the present disclosure.

Memory subsystem 122 can include a number of memories such as main RAM 126 (e.g., static RAM, dynamic RAM, etc.) for storage of instructions and data during program execution, and ROM (read-only memory) 124 on which fixed instructions and data can be stored. File storage subsystem 128 can provide persistent (i.e., non-volatile) storage for program and data files, and can include storage technologies such as solid-state drive and/or other types of storage media known in the art.

CPUs 108 can run a network operating system stored in storage subsystem 120. A network operating system is a specialized operating system for network device 100. For example, the network operating system can be the Arista EOS® operating system, which is a fully programmable and highly modular, Linux-based network operating system developed and sold/licensed by Arista Networks, Inc. of Santa Clara, California. It is understood that other network operating systems may be used.

Bus subsystem 130 can provide a mechanism for the various components and subsystems of management module 102 to communicate with each other as intended. Although bus subsystem 130 is shown schematically as a single bus, alternative embodiments of the bus subsystem can utilize multiple buses.

The one or more I/O modules 106a-106p can be collectively referred to as the data plane of network device 100 (also referred to as the data layer, forwarding plane, etc.). Interconnect 104 represents interconnections between modules in the control plane and modules in the data plane. Interconnect 104 can be any suitable bus architecture such as Peripheral Component Interconnect Express (PCIe), System Management Bus (SMBus), Inter-Integrated Circuit (I²C), etc.

I/O modules 106a-106p can include respective packet processing hardware comprising packet processors 112a-112p (collectively 112) to provide packet processing and forwarding capability. Each I/O module 106a-106p can be further configured to communicate over one or more ports 110a-110n on the front panel 110 to receive and forward network traffic. Packet processors 112 can comprise hardware (circuitry), including for example, data processing hardware such as an application specific integrated circuit (ASIC), field programmable gate array (FPGA), processing unit, and the like, which can be configured to operate in accordance with the present disclosure. Packet processors 112 can include forwarding lookup hardware (forwarding tables) such as, for example, but not limited to content addressable memory such as ternary CAMs (TCAMs) and auxiliary memory such as static RAM (SRAM).

Memory hardware 114 can include buffers used for queueing packets. I/O modules 106a-106p can access memory hardware 114 via crossbar 118. It is noted that in other embodiments, the memory hardware 114 can be incorporated into each I/O module. The forwarding hardware in conjunction with the lookup hardware can provide wire speed decisions on how to process ingress packets and outgoing packets for egress. In accordance with some embodiments, some aspects of the present disclosure can be performed wholly within the data plane.

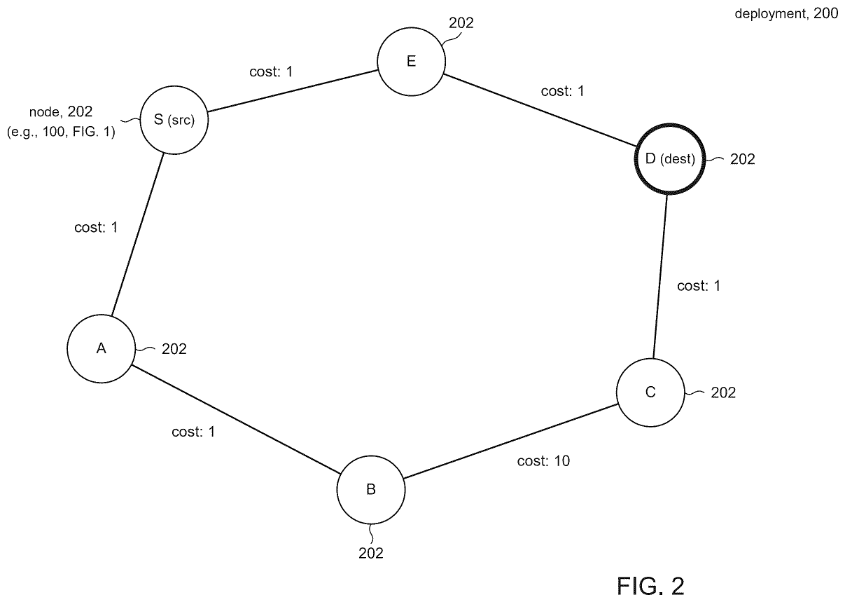

FIG. 2 is a logical representation of an illustrative deployment 200 used as an example to explain processing in accordance with the present disclosure. The deployment 200 comprises a plurality of nodes 202, such as network device 100 shown in FIG. 1 for example. Each link between nodes A, B, C, D, E, and S is shown with a corresponding cost metric that represents a cost of transmitting a packet on the link. In some embodiments, some links may be unidirectional. For discussion purposes, we can assume without loss of generality that all the links are bi-directional. Further for discussion purposes, the examples will refer to node S (source) forwarding traffic to node D (destination).

In accordance with some embodiments, nodes 202 can use an Interior Gateway Protocol (IGP) to share routing information and state information (up/down state, metrics, etc.) between themselves. IGP refers to any one of a group of protocols for exchanging routing table information (e.g., link state information). IGP protocols include Open Shortest Path First (OSPF), Intermediate System-to-Intermediate System (IS-IS), Routing Information Protocol (RIP), and Enhanced Interior Gateway Routing Protocol (EIGRP), and others.

### Computing Convergence

IGP provides messaging between adjacent nodes 202 to advertise their information such as distance to the adjacent node, status of the link to the adjacent node, and so on. Each node 202 periodically advertises the information it has collected to its adjacent nodes and conversely receives similar advertisements from adjacent nodes. Using these routing advertisements, each node 202 can compute the shortest path to other nodes; e.g., the shortest path between node S and node D is path [S, E, D] with a cost of 2. Each node populates its routing/forwarding tables based on the shortest path information. Advertisements are repeatedly performed, allowing each node to eventually converge to a shortest path for every other node in the deployment. This process is referred to as convergence and continues until the routing/forwarding tables of the nodes 202 converge to stable values. When a topology change in the network occurs (e.g., a link or node), another round of convergence (called re-convergence) commences.

### Computing Shortest Path

Using IGP, each node 202 can determine a shortest path to each other node. The shortest path for example, can be based on the link cost. The link cost (or simply cost) between any two nodes can be computed from or otherwise based on any suitable criteria. For example, the cost can be determined as a function of the bandwidth of the communication link between the nodes 202, the presence/absence of Equal Cost Multipath (ECMP), the presence/absence of link aggregation (LAG), link delay, and so on.

Consider node S in FIG. 2, for example. The shortest paths from node S to each of the other nodes, based on link cost, would be:
S to A is S-A
S to B is S-A-B
S to C is S-E-D-C
S to D is S-E-D
S to E is S-E
   If two paths have the same cost, the tie can be resolved using any suitable tie-breaking criteria to select the shortest path.

### Computing Backup Paths

In addition to computing shortest paths, each node in the deployment can compute backup paths to other nodes to be used in the event of failure of a resource between the nodes. In the context of the present disclosure, a “resource” can be a link to a directly connected (neighbor) node, links in the shared risk link group (SRLG) of a failed link, a neighbor node, and the like. Backup paths can be pre-computed prior to or at the time of deployment.

A backup path to protect a failed resource between two nodes is any path that excludes the failed resource. Heuristics for computing backup paths are known. Briefly, in some embodiments for example, a backup path can be determined based on the topology of the deployment by removing the failed resource from the topology and applying a suitable path finding algorithm. The topology can be computed and stored in each network device, downloaded from a central controller, and so on.

With reference to FIG. 2, consider computing a backup path for forwarding traffic from node S to node D where the protected resource (i.e., failed resource) is the S-E link:
Based on the topology shown in FIG. 2, the backup path that protects the S-E link is [S, A, B, C, D]. FIG. 2 is a highly simplified deployment for discussion purposes. It will be appreciated that in a real-life deployment, there can be multiple candidates for a backup path. The selection of a backup path from multiple candidates can be based on any suitable criteria such as link cost.
Identify, from the nodes in the computed backup path, a Q node of node D with respect to link S-E in accordance with RFC 7490. Per RFC 7490, the Q-space of a given node with respect to a protected resource is the set of nodes that can reach the given node using the pre-convergence (i.e., prior to failure of the resource) shortest path without transiting the protected resource.
In our example, the Q-space of D with respect to the S-E link (protected resource) is the set {C, D, E}. Note, for each of nodes S, A, and B, the pre-convergence (prior to link failure) shortest path to D includes the S-E link (protected resource), and so nodes S, A, and B do not qualify as Q-space nodes.
In some embodiments, the Q node for the backup path can be a node selected from the Q-space that is closest to node S and satisfies the path cost equation:

$$QD < QS + SD , \qquad [ Eqn . 1 ]$$

where the notation “QD” refers to the path cost from a node Q to node D. In our example, the Q node for the backup path is node C.
The above path cost equation is used when the protected resource is a link, which in our example is the S-E link. When the protected resource is a node (e.g., node E), the following path cost equation can be used to select the Q node:

$$QD < QE + ED , \qquad [ Eqn . 2 ]$$

with the understanding that the computed Q-space would be different.
Identify, from the nodes in the computed backup path, a P node of node S with respect to link S-E in accordance with RFC 7490. Per RFC 7490, the P-space of a given node with respect to a protected resource is the set of nodes reachable from the given node using the pre-convergence shortest paths without transiting the protected resource. RFC 7490 notes that because a given node will only use a backup path when it has detected the failure of the resource, the initial hop of the backup path need not be subject to the given node's normal forwarding decision process. RFC 7490 introduces the concept of “extended P-space.” The extended P-space of a given node is the union of the P-spaces of the neighbors of the given node, excluding the P-space of the neighbor affected by the failed resource.
In our example, the P-space of S with respect to link S-E is the set of nodes that can be reached from S without transiting the protected link S-E, which is the set {A, B}. Note, for each of nodes C, D, and E, the pre-convergence shortest path from node S includes the S-E link (protected resource), and so nodes C, D, and E do not qualify as P-space nodes. The extended P-space of S with respect to link S-E is {A, B}.
In some embodiments, the P node for the backup path can be a node selected from the P-space that is furthest from node S and satisfies the path cost equation:

$$AP < A S + SP . \qquad [ Eqn . 3 ]$$

In our example, however, node B is the only node from the backup path that is in the extended P space and so the P node for the backup path is node B.
The above path cost equation is used when the protected resource is a link, which in our example is the S-E link. When the protected resource is a node (e.g., node E), the following path cost equation can be used to select the P node:

$$AP < AE + EP , \qquad [ Eqn . 4 ]$$

with the understanding that the P-and extended P-spaces would be different.
Stitching—The backup path can now be revised and expressed in terms of the P node, the Q node and the destination node. In our example, the revised backup path is [B, C, D], where node B is the P node, node C is the Q node, and the destination is node D.
Because the backup path is computed prior to any failure in the topology, the shortest path from the P node to the Q node may transit the intended protected resource. In some embodiments, the P and Q nodes can be “stitched” to specify a path from P to Q that does not transit the protected resource. The final backup path can then be expressed as [P, P-Q, Q, D], where the hyphen notation “P-Q” represents zero, one, or more hops from P to Q.
In the example topology of FIG. 2, the traversal from B to C will not transit the S-E link (the protected resource) and so stitching is not required. However, some analysis is needed to determine if B can reach C without stitching, so the final backup path is still [B, B-C, D].

The foregoing example, computes the backup path for forwarding traffic from node S to node D where the protected resource (i.e., failed resource) is the S-E link. Node S can repeat the computation to compute a backup path to D where the protected resource is node E itself. Furthermore, S can repeat the computation for every other node in the deployment that can be a forwarding destination, and for each possible protected resource (e.g., link down, node down) on the shortest path to each such forwarding destination. Finally, each node in the deployment can perform these backup path computations; e.g., node A can compute backup paths to node E, backup paths to node D, and so on. Because these backup paths are computed in advance of an actual failure (e.g., at the time of deployment, when the device is powered up, etc.), they can be referred to as “pre-computed” backup paths.

In accordance with the present disclosure, a “snapshot” of the deployment can be taken. The snapshot can comprise information that represents the topology of the deployment (e.g., nodes, links, etc.) at the time the backup paths are computed, prior to the occurrence of any resource failures. As explained below, the snapshot can be used to validate the backup path in accordance with the present disclosure.

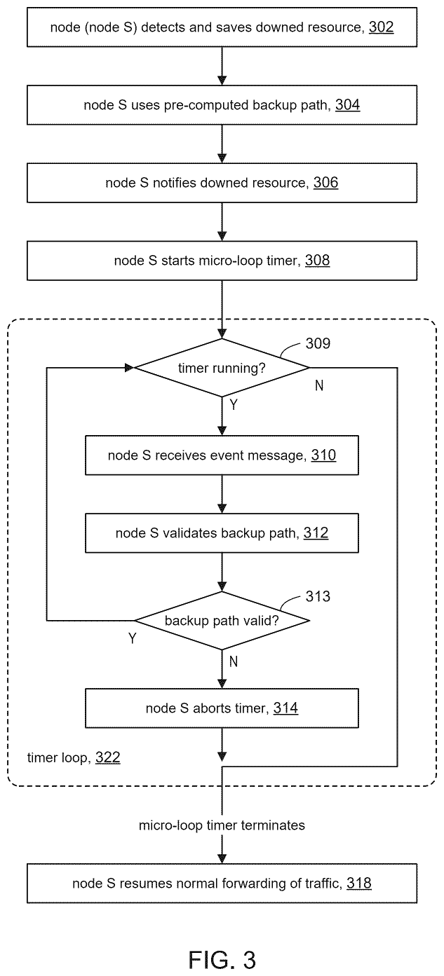

Referring to FIG. 3, the discussion will now turn to a high-level description of processing in a network device (e.g., 100, FIG. 1, nodes 202, FIG. 2) in accordance with the present disclosure to facilitate re-convergence when the network topology changes; e.g., due to a failed resource. Depending on a given implementation, the processing may be performed entirely in the control plane or entirely in the data plane, or the processing may be divided between the control plane and the data plane. In some embodiments, the network device can include one or more processing units (circuits), which when operated, can cause the network device to perform processing in accordance with FIG. 3. Processing units (circuits) in the control plane, for example, can include general CPUs that operate by way of executing computer program code stored on a non-volatile computer readable storage medium (e.g., read-only memory); e.g., CPU 108 in the control plane (FIG. 1) can be a general CPU. Processing units (circuits) in the data plane can include specialized processors such as digital signal processors, field programmable gate arrays, application specific integrated circuits, and the like, that operate by way of executing computer program code or by way of logic circuits being configured for specific operations. For example, each of the packet processors 112a-112p in the data plane (FIG. 1) can be a specialized processor. The operation and processing blocks described below are not necessarily executed in the order shown. Operations can be combined or broken out into smaller operations in various embodiments. Operations can be allocated for execution among one or more concurrently executing processes and/or threads.

The example deployment shown in FIG. 2 will serve as an example to illustrate the following operations. It will be understood that the operations can be performed in any of the nodes 202 in deployment 200. Operations are described with respect to a node (e.g., node S) that is forwarding traffic to a destination node (e.g., node D) where a failure occurs on the shortest path (i.e., [S, E, D]) between S and D. It is understood that prior to a resource failing, node S can receive and forward traffic according to forwarding information in its forwarding tables.

At operation 302, node S can detect a downed resource on the shortest path to node D. In the context of the present disclosure, a resource can be a failed link to a neighbor node, the neighbor node itself, etc. Links in an SRLG can fail at the same time, and so in some embodiments, when a link in an SRLG fails, all links in the SRLG can be protected as well as protecting the failed link. In our example, suppose the S-E link has failed. In accordance with the present disclosure, node S can store information about the downed resource to preserve the portion of the network topology associated with the downed resource. As explained below, a snapshot of the portion of the network topology associated with the downed resource can be used to validate the backup path.

At operation 304, node S can begin forwarding traffic to node D on a pre-computed backup path associated with the failed resource instead of normal forwarding processing using the node's routing/forwarding tables. In some embodiments, for example, packets transmitted on the backup path can include a label stack (e.g., in a Multiprotocol Label Switching, MPLS, deployment) having labels pushed on a stack that specifies nodes along the backup path. The label stack forces each node to forward the packet along the backup path; the backup path is not determined using the forwarding tables. As explained above, the pre-computed backup path that protects the S-E link is [S, A, B, B-C, D], where B is the P node and C is the Q node. The label stack in the packet represents the path [S, A, B, B-C, D].

At operation 306, node S transmits (advertises) an event message (notification) to the other nodes in response to the detection of the downed resource, for example, using a suitable IGP. In our example, for instance, node S can advertise to the other nodes that it cannot reach node E. This message can serve to trigger re-convergence as other nodes receive and respond to the message; e.g., updating their tables, advertising their updates, and so on.

At operation 308, node S can start a timer to initiate processing in timer loop 322. As noted above, the notification at operation 306 triggers the other nodes to begin re-converging in order to learn new routes to account for the change in topology due to the failed resource and update their respective routing/forwarding tables. Each node, including node S, gradually learns new routes by advertising to the other nodes which neighbors it can reach, and by receiving advertisements from other nodes about which neighbors they can reach. In the meanwhile, traffic from S to D is forwarded on the backup path because, until the routing/forwarding tables in the deployment are updated, there is a chance of a micro-loop if the old routing/forwarding information is used. The timer gives nodes in the deployment time to re-converge. So long as the timer is running, node S forwards traffic to D on the backup path to avoid micro-loops; for this reason the timer can be referred to as the micro-loop timer. The duration of the timer loop (i.e., the value of the micro-loop timer) can be any suitable time (e.g., on the order of one second to several seconds), depending on the deployment. At decision point 309, if the timer is running, then processing can proceed on the Y branch to operation 310. If the timer has expired (not running), then processing can proceed on the N branch to operation 318.

At operation 310, node S can continue forwarding traffic to D on the backup path. When S receives an event message from another node, S can process the event message. The event message can include notifications of changes in state, topology, device configuration, etc. Node S can take action appropriate to the event message; e.g., update its own state, update its configuration, update its routing/forwarding tables, take no action, and so on. In accordance with the present disclosure, when node S receives an event message, node S continues to let the micro-loop timer run and proceeds to operation 312, irrespective of whether the event message is correlated (i.e., relates to the downed resource) or is uncorrelated. In our example, for instance, a message that indicates node E is down is related to the S-E link failure and is a correlated event. A message that indicates the B-C link has failed would be an example of an uncorrelated event. In accordance with the present disclosure, when node S receives either event message the micro-loop continues to run.

At operation 312, node S, in response to receiving an event message from another node, can make a determination whether the backup path is valid or not valid. Note that, in accordance with the present disclosure, the micro-loop timer continues to run while node S validates the backup path. In some embodiments, validation of the pre-computed backup path includes recomputing the backup path using an earlier version of the topology that includes the failed resource (in our example the S-E link). Generally:
Revise the current topology by adding back to the current topology the failed resource to obtain a “revised topology”.
Compute the current link costs in the revised topology.
Recompute the P-space, the extended P-space, and the Q-space for the revised topology.
Evaluate the path cost equation Eqn. 1 for the Q node in the backup path, and if the path cost equation does not hold, then the backup path can be deemed invalid.
Evaluate the path cost equation Eqn. 3 for the P node in the backup path, and if the path cost equation does not hold, then the backup path can be deemed invalid.
If the path cost equations Eqns. 1 and 3 hold, then the backup path can be deemed to still be valid in the current topology.
In our example, we use path cost Eqns. 1 and 3 for failed S-E link. In a situation where node E has failed, path cost Eqns. 2 and 4 would be used to validate the backup path.
   An example of this aspect of the present disclosure is described below. If the backup path is determined to be valid (decision point 313), then processing can continue on the Y branch and return to operation 310 to continue processing in the timer loop 322 as long as the timer is running. If the backup path is determined to be not valid, then processing can continue on the N branch to operation 314.

At operation 314, node S can abort the micro-loop timer in response to a determination that the backup path is no longer valid, thus terminating the timer loop 322. Node S can discontinue using the backup path and delete the backup path as it is no longer valid. Node S can terminate processing in timer loop 322 and proceed to operation 318, where node S will resume forwarding traffic using its routing/forwarding tables.

At operation 318, node S can resume normal forwarding of traffic to node D using its routing/forwarding tables in response to termination of the timer loop 322. Processing in accordance with FIG. 3 can be deemed complete.

In accordance with the present disclosure, instead of blindly aborting the micro-loop timer and resuming forwarding processing using routing/forwarding tables when an uncorrelated event message is received, node S can can continue to forward traffic using the backup path thus reducing the risk of a micro-loop as the deployment re-converges. At the same time, node S validates the backup path in response to receiving an event message, and so can react to the backup path having become invalid; i.e., by aborting the micro-loop timer and resuming forwarding processing using routing/forwarding tables. Embodiments in accordance with the present disclosure, maximize the use of the backup path during re-convergence while at the same time allowing for the backup path to be terminated as soon as it is determined to be no longer valid.

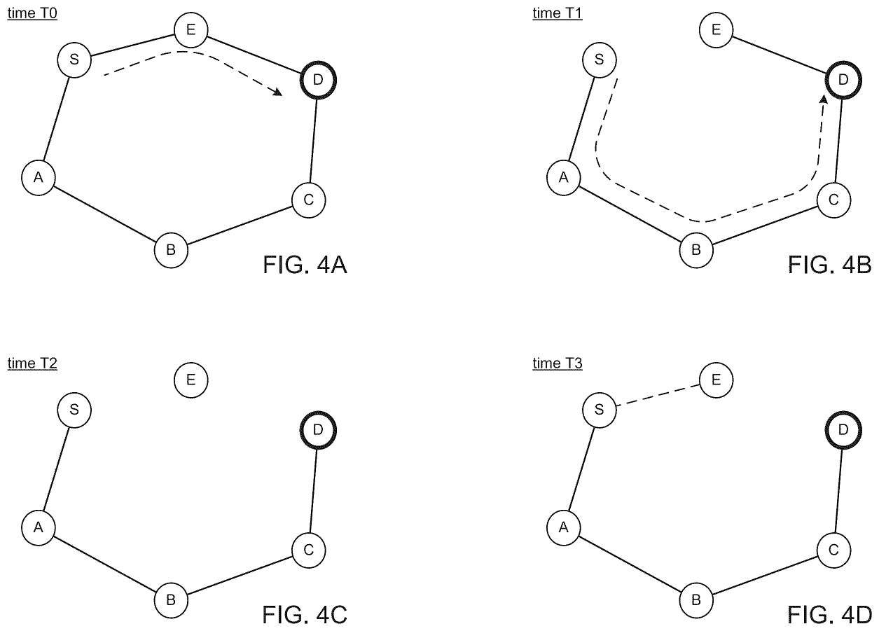

Referring to FIGS. 4A-4D, the discussion will now turn to a description of validating the backup path (operation 312, FIG. 3) in accordance with the present disclosure. The description will continue with the network example used to explain the operations in FIG. 3.

FIG. 4A shows, at time TO, the initial topology. Initially, node S, using its routing/forwarding tables, forwards traffic to node D on the path [S, E, D] (the shortest path from node S to node D).

Suppose, at time T1, that the S-E link fails. FIG. 4B shows the resulting change in topology due to a failure of the S-E link. FIG. 4B also shows the pre-computed backup path [S, A, B, C, D] used by node S to forward traffic to node D in response to the failed S-E link, where node B is the P node and node C is the Q node.

Suppose, at time T2, the E-D link is removed. FIG. 4C shows the resulting change in topology due to removal of the E-D link.

Suppose, at time T3, node S receives an event message (at operation 310) subsequent to time T2. In accordance with the present disclosure, node S performs validation of the backup path (at operation 312) in response to receiving an event message. As explained at operation 312, validation of the backup path includes recomputing the backup path using an earlier version of the topology that includes the failed resource (in our example the S-E link). More specifically, the failed resource is added to the current state of the topology. In this example, for instance, FIG. 4C represents the current topology (E-D link removed) at the time node S receives an event message.

FIG. 4D illustrates a “revised” topology, which is the current state of the topology at the time of receipt of the event message, revised by adding the failed resource, namely the S-E link, to the current topology; for example, using the snapshot taken at the time the backup paths were computed. Node S recomputes the backup path for the failed resource using the revised topology. The old P and Q nodes are selected from the recomputed backup path. If node B is still the P node and node C is still the Q node and if the links connecting P and Q node are still in the topology, then the original pre-computed backup path is deemed to still be valid; otherwise, the original pre-computed backup path may no longer be valid and additional verification would be needed to determine its validity.

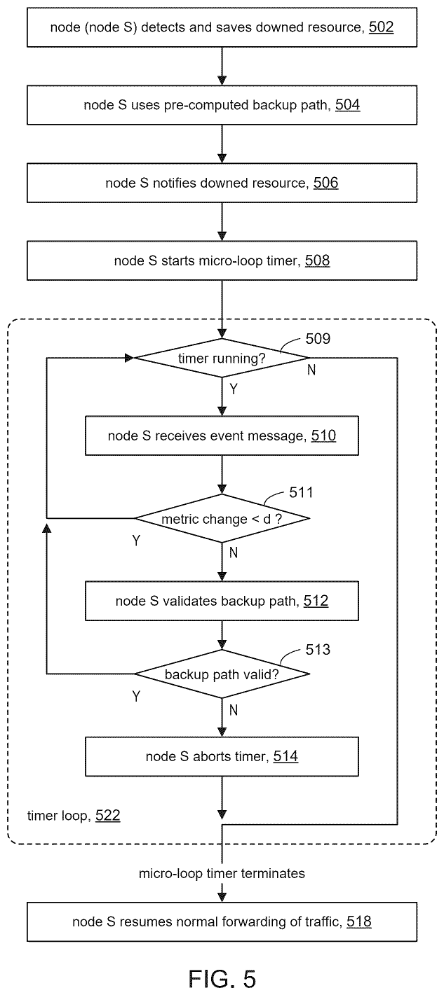

Referring to FIG. 5, the discussion will now turn to a high-level description of processing in a network device (e.g., 100, FIG. 1, nodes 202, FIG. 2) in accordance with the present disclosure to facilitate re-convergence when the network topology changes; e.g., due to a failed resource followed by metric changes. Whereas the backup path validation in FIG. 3 is triggered in response to receiving any event message, FIG. 5 shows that in some embodiments backup path validation can be triggered when the event message relates to a metric change message.

As in FIG. 3, the example deployment shown in FIG. 2 will serve as an example to illustrate the following operations. It will be understood that the operations can be performed in any of the nodes 202 in deployment 200. Operations are described with respect to a node (e.g., node S) that is forwarding traffic to a destination node (e.g., node D) where a failure occurs on the shortest path (i.e., [S, E, D]) between S and D. It is understood that prior to a resource failing, node S can receive and forward traffic according to forwarding information in its forwarding tables.

At operation 502, node S can detect a downed resource on the shortest path to node D. In the context of the present disclosure, a resource can be a failed link to a neighbor node, the neighbor node itself, etc. Links in an SRLG can fail at the same time, and so in some embodiments, when a link in an SRLG fails, all links in the SRLG can be protected in addition to the failed link. In our example, for instance, the S-E link has failed. As noted above, node S can store information about the downed resource to preserve the portion of the network topology associated with the downed resource. A snapshot of the portion of the network topology associated with the downed resource can be used to validate the backup path.

At operation 504, node S can begin forwarding traffic to node D on a pre-computed backup path associated with the failed resource instead of normal forwarding processing using the node's routing/forwarding tables. In some embodiments, for example, packets transmitted on the backup path can include a label stack (e.g., in a Multiprotocol Label Switching, MPLS, deployment) having labels pushed on a stack that specifies nodes along the backup path. The label stack forces each node to forward the packet along the backup path; the backup path is not determined using the forwarding tables. As explained above, the pre-computed backup path that protects the S-E link is [S, A, B, B-C, D], where B is the P node and C is the Q node. The label stack in the packet represents the path [S, A, B, B-C, D].

At operation 506, node S transmits (advertises) a notification to the other nodes in response to the detection of the downed resource, for example, using a suitable IGP. In our example, for instance, node S can advertise to the other nodes that it cannot reach node E. This message can serve to trigger re-convergence as other nodes receive and respond to the message; e.g., updating their tables, advertising their updates, and so on.

At operation 508, node S can start a timer to start processing in a timer loop 522. As explained above, the notification at operation 506 triggers the other nodes to begin re-converging in order to learn new routes and update their respective routing/forwarding tables. Each node, including node S, gradually learns new routes by advertising to the other nodes which neighbors it can reach, and by receiving advertisements from other nodes about which neighbors they can reach. Traffic from S to D is forwarded on the backup path because, until the routing/forwarding tables in the deployment are updated, there is a chance of a micro-loop if the old routing/forwarding information is used. The timer gives nodes in the deployment time to re-converge. The duration of the timer loop (i.e., the value of the micro-loop timer) can be any suitable time (e.g., on the order of one second to several seconds), depending on the deployment. At decision point 509, if the timer is running, then processing can proceed on the Y branch to operation 510. If the timer has expired (not running), then processing to proceed on the N branch to operation 518.

At operation 510, node S can continue forwarding traffic to D on the backup path. When S receives an event message from another node, S can process the event message. The event message can include notifications of changes in state, topology, device configuration, etc. Node S can take action appropriate to the event message; e.g., update its own state, update its configuration, update its routing/forwarding tables, take no action, and so on.

In some embodiments, node S can determine if the event message is a metric change event. A “metric” in this context refers to a number that is used to indicate preference of one path over another path. For example, path selection in accordance with the Border Gateway Protocol (BGP) can be based on various metrics such as weight, local weight, MED, etc. Other routing protocols have their own metrics for path selection. Changes to this kind of metric can be advertised as a “metric change event.” If the event message is not a metric change message then processing can continue to operation 512.

If the event message is a metric change message, node S can determine at decision point 511 if the metric change has adversely affected the path cost of the backup path. If the path cost is deemed to have been adversely affected, then processing can proceed to operation 512 to perform a validation of the backup path. If the path cost is deemed not to have been adversely affected, then processing can continue with operation 510 to continue processing in the timer loop 522 as long as the timer is running. In the case that the metric change has not adversely affected the path cost of the backup path, it is possible that the backup path in use may not be the current shortest path to the destination.

In some embodiments, node S can perform the following to determine if the metric change event is deemed to have adversely affected the path cost of the backup path:
set accumulatedMetric=0 at the beginning of the timer
for a protected link, compute:
   d=MIN (AS+SP−AP, QS+SD−QD), where P and Q in our example are nodes B and C respectively and “d” is a predetermined cost threshold based on the precomputed backup path
   accumulatedMetric=accumulatedMetric+ABS (metricChange) (metricChange is received in the event message)
   if accumulatedMetric<d, then the metric change can be deemed not to have adversely affected the path cost of the backup path (processing can continue with operation 510)
   if accumulatedMetric≥d, then the metric change can be deemed to have adversely affected the path cost of the backup path (processing can continue with operation 512),
for a protected node, compute:
   d=MIN (AS+SP−AP, AE+EP−AP, QE+ED−QD), where “d” is a predetermined cost threshold based on the precomputed backup path accumulatedMetric=accumulatedMetric+ABS (metricChange) (metricChange is received in the event message)
   if accumulatedMetric<d, then the metric change can be deemed not to have adversely affected the path cost of the backup path (processing can continue with operation 510)
   if accumulatedMetric≥d, then the metric change can be deemed to have adversely affected the path cost of the backup path (processing can continue with operation 512),
where MIN( ) is the minimum function that returns the minimum of the parameters passed to the function and ABS( ) returns the absolute value of the passed parameter.
   The test using the predetermined cost threshold ‘d’ can avoid the time-consuming operation of validating the backup path when the event message is a metric change message.

At operation 512, node S, in response to receiving a metric change message from another node, can make a determination whether the backup path is valid or not. Note that, in accordance with the present disclosure, the micro-loop timer continues to run while node S validates the backup path. In accordance with the present disclosure, validation of the pre-computed backup path includes recomputing the backup path using an earlier version of the topology that includes the failed resource (in our example the S-E link). Generally:
Revise the current topology by adding back to the current topology the failed resource to obtain a “revised topology”.
Compute the current link costs in the revised topology.
Recompute the P-space, the extended P-space, and the Q-space for the revised topology.
Evaluate the path cost equation Eqn. 1 for the Q node in the backup path, and if the path cost equation does not hold, then the backup path can be deemed invalid.
Evaluate the path cost equation Eqn. 3 for the P node in the backup path, and if the path cost equation does not hold, then the backup path can be deemed invalid.
If the path cost equations Eqns. 1 and 3 hold, then the backup path can be deemed to still be valid in the current topology.
In our example, we use path cost Eqns. 1 and 3 for failed S-E link. In a situation where node E has failed, path cost Eqns. 2 and 4 would be used to validate the backup path.
   If the backup path is determined to be valid (decision point 513), then processing can continue on the Y branch and return to operation 510 to continue processing in the timer loop 522 as long as the timer is running. If the backup path is determined to be not valid, then processing can continue on the N branch to operation 514.

At operation 514, node S can abort the micro-loop timer in response to a determination that the backup path is no longer valid, thus terminating the timer loop 522. Node S can discontinue using the backup path and delete the backup path as it is no longer valid. Node S can terminate processing in timer loop 522 and proceed to operation 518, where node S will resume forwarding traffic using its routing/forwarding tables.

At operation 518, node S can resume normal forwarding of traffic to node D using its routing/forwarding tables in response to termination of the timer loop 522. Processing in accordance with FIG. 5 can be deemed complete.

### Further Examples

Features described above as well as those claimed below may be combined in various ways without departing from the scope hereof. The following examples illustrate some possible, non-limiting combinations:

(A1) A method in a network device among a plurality of network devices in a deployment, the method comprising: forwarding traffic to a destination network device using forwarding tables in the network device; detecting occurrence of a failed resource between the network device and a neighbor network device on a path to the destination network device; advertising a message to the plurality of network devices in the deployment in response to the occurrence of the failed resource; forwarding traffic, received subsequent to detecting the failed resource, to the destination network device using a backup path in response to detecting the failed resource instead of forwarding the subsequent traffic using the forwarding tables; and initiating a timer, wherein as long as the timer is running: continue forwarding the subsequent traffic to the destination network device using the backup path; and assessing validity of the backup path, wherein in response to the backup path being assessed to be invalid, terminating timer and forwarding the subsequent traffic to the destination device using the forwarding tables.

(A2) For the method denoted as (A1), wherein assessing validity of the backup path is performed in response to receiving an event message advertised by another network device in the deployment.

(A3) For the method denoted as any of (A1) through (A2), wherein assessing validity of the backup path is performed in response to receiving an event message advertised by a network device in the plurality of network devices, wherein the event message indicates occurrence of a metric change in the deployment and assessing validity of the backup path is based on the metric change.

(A4) The method denoted as any of (A1) through (A3), further comprising storing information that represents a snapshot of the deployment at a time of computing the backup path, wherein validity of the backup path is assessed based on the snapshot topology.

(A5) For the method denoted as any of (A1) through (A4), wherein validity of the backup path is assessed based on a current topology of the deployment revised by adding the downed link to the current topology.

(A6) For the method denoted as any of (A1) through (A5), wherein in response to the backup path being assessed to be valid, continue forwarding the subsequent traffic to the destination network device using the backup path as long as the timer is running.

(A7) The method denoted as any of (A1) through (A6), further comprising selecting the backup path based on the failed resource.

(A8) The method denoted as any of (A1) through (A7), further comprising, in response to the timer expiring, resuming the forwarding of traffic to the destination network device using the forwarding tables.

(A9) For the method denoted as any of (A1) through (A8), wherein the backup path is represented as label stack in packets of the subsequent traffic.

(A10) For the method denoted as any of (A1) through (A9), wherein the failed resource is a link that connects the network device to a neighbor network device, a neighbor network device, or links in a shared risk link group (SRLG) of a failed link.

(B1) A network device comprising: one or more computer processors; and a computer-readable storage device comprising instructions for controlling the one or more computer processors to: forward traffic to a destination network device using forwarding tables in the network device; forward the traffic to the destination network device using a backup path in response to detecting a failed resource between the network device and a neighbor network device instead of forwarding the traffic using the forwarding tables; initiate a timer, wherein the traffic is forwarded to the destination network device using the backup path while the timer is running; and making a plurality of assessments of validity of the backup path, wherein in response to the backup path being assessed to be invalid, terminating the timer and resume forwarding the traffic to the destination device using the forwarding tables.

(B2) For the network device denoted as (B1), wherein assessing the validity of the backup path is performed in response to receiving an event message advertised by another network device in the deployment.

(B3) For the network device denoted as any of (B1) through (B2), wherein assessing the validity of the backup path is performed in response to receiving an event message advertised by a network device in the plurality of network devices, wherein the event message indicates occurrence of a metric change in the deployment and assessing validity of the backup path is based on the metric change.

(B4) For the network device denoted as any of (B1) through (B3), wherein the validity of the backup path is assessed based on revising a current topology of the deployment by adding the downed link to the current topology.

(B5) For the network device denoted as any of (B1) through (B4), wherein traffic is forwarded to the destination network device using forwarding tables in the network device subsequent to expiration of the timer.

(B6) For the network device denoted as any of (B1) through (B5), wherein the computer-readable storage device further comprises instructions for controlling the one or more computer processors to select the backup path based on the failed resource.

(C1) A non-transitory computer-readable storage device in a network device, the non-transitory computer-readable storage device having stored thereon computer executable instructions, which when executed, cause the network device to: forward traffic to a destination network device using forwarding tables in the network device; forward the traffic to the destination network device using a backup path in response to detecting a failed resource between the network device and a neighbor network device instead of forwarding the traffic using the forwarding tables; initiate a timer, wherein the traffic is forwarded to the destination network device using the backup path while the timer is running; and making a plurality of assessments of validity of the backup path, wherein in response to the backup path being assessed to be invalid, terminating timer and resume forwarding the traffic to the destination device using the forwarding tables.

(C2) For the non-transitory computer-readable storage device denoted as (C1), wherein assessing the validity of the backup path is performed in response to receiving an event message advertised by another network device in the deployment.

(C3) For the non-transitory computer-readable storage device denoted as any of (C1) through (C2), wherein assessing the validity of the backup path is performed in response to receiving an event message advertised by a network device in the plurality of network devices, wherein the event message indicates occurrence of a metric change in the deployment and assessing validity of the backup path is based on the metric change.

(C4) For the non-transitory computer-readable storage device denoted as any of (C1) through (C3), wherein the validity of the backup path is assessed based on a current topology of the deployment revised by adding the downed link to the current topology.

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents may be employed without departing from the scope of the disclosure as defined by the claims.

1. A method in a network device among a plurality of network devices in a deployment, the method comprising:
forwarding traffic to a destination network device using forwarding tables in the network device;
detecting occurrence of a failed resource between the network device and a neighbor network device on a path to the destination network device;
advertising a message to the plurality of network devices in the deployment in response to the occurrence of the failed resource;
forwarding traffic, received subsequent to detecting the failed resource, to the destination network device using a backup path in response to detecting the failed resource instead of forwarding the subsequent traffic using the forwarding tables; and
initiating a timer, wherein as long as the timer is running:
continue forwarding the subsequent traffic to the destination network device using the backup path; and
assessing validity of the backup path, wherein in response to the backup path being assessed to be invalid, terminating timer and forwarding the subsequent traffic to the destination device using the forwarding tables.

2. The method of claim 1, wherein assessing validity of the backup path is performed in response to receiving an event message advertised by another network device in the deployment.

3. The method of claim 1, wherein assessing validity of the backup path is performed in response to receiving an event message advertised by a network device in the plurality of network devices, wherein the event message indicates occurrence of a metric change in the deployment and assessing validity of the backup path is based on the metric change.

4. The method of claim 1, further comprising storing information that represents a snapshot of the deployment at a time of computing the backup path, wherein validity of the backup path is assessed based on the snapshot topology.

5. The method of claim 1, wherein validity of the backup path is assessed based on a current topology of the deployment revised by adding the downed link to the current topology.

6. The method of claim 1, wherein in response to the backup path being assessed to be valid, continue forwarding the subsequent traffic to the destination network device using the backup path as long as the timer is running.

7. The method of claim 1, further comprising selecting the backup path based on the failed resource.

8. The method of claim 1, further comprising, in response to the timer expiring, resuming the forwarding of traffic to the destination network device using the forwarding tables.

9. The method of claim 1, wherein the backup path is represented as label stack in packets of the subsequent traffic.

10. The method of claim 1, wherein the failed resource is a link that connects the network device to a neighbor network device, a neighbor network device, or links in a shared risk link group (SRLG) of a failed link.

11. A network device comprising:
one or more computer processors; and
a computer-readable storage device comprising instructions for controlling the one or more computer processors to:
forward traffic to a destination network device using forwarding tables in the network device;
forward the traffic to the destination network device using a backup path in response to detecting a failed resource between the network device and a neighbor network device instead of forwarding the traffic using the forwarding tables;
initiate a timer, wherein the traffic is forwarded to the destination network device using the backup path while the timer is running; and
making a plurality of assessments of validity of the backup path, wherein in response to the backup path being assessed to be invalid, terminating the timer and resume forwarding the traffic to the destination device using the forwarding tables.

12. The network device of claim 11, wherein assessing the validity of the backup path is performed in response to receiving an event message advertised by another network device in the deployment.

13. The network device of claim 11, wherein assessing the validity of the backup path is performed in response to receiving an event message advertised by a network device in the plurality of network devices, wherein the event message indicates occurrence of a metric change in the deployment and assessing validity of the backup path is based on the metric change.

14. The network device of claim 11, wherein the validity of the backup path is assessed based on revising a current topology of the deployment by adding the downed link to the current topology.

15. The network device of claim 11, wherein traffic is forwarded to the destination network device using forwarding tables in the network device subsequent to expiration of the timer.

16. The network device of claim 11, wherein the computer-readable storage device further comprises instructions for controlling the one or more computer processors to select the backup path based on the failed resource.

17. A non-transitory computer-readable storage device in a network device, the non-transitory computer-readable storage device having stored thereon computer executable instructions, which when executed, cause the network device to:
forward traffic to a destination network device using forwarding tables in the network device;
forward the traffic to the destination network device using a backup path in response to detecting a failed resource between the network device and a neighbor network device instead of forwarding the traffic using the forwarding tables;
initiate a timer, wherein the traffic is forwarded to the destination network device using the backup path while the timer is running; and
making a plurality of assessments of validity of the backup path, wherein in response to the backup path being assessed to be invalid, terminating timer and resume forwarding the traffic to the destination device using the forwarding tables.

18. The non-transitory computer-readable storage device of claim 17, wherein assessing the validity of the backup path is performed in response to receiving an event message advertised by another network device in the deployment.

19. The non-transitory computer-readable storage device of claim 17, wherein assessing the validity of the backup path is performed in response to receiving an event message advertised by a network device in the plurality of network devices, wherein the event message indicates occurrence of a metric change in the deployment and assessing validity of the backup path is based on the metric change.

20. The non-transitory computer-readable storage device of claim 17, wherein the validity of the backup path is assessed based on a current topology of the deployment revised by adding the downed link to the current topology.
